(19) United States
(12) Patent Application Publication
(10) Pub. No.: US 2004/0142315 A1
(43) Pub. Date: Jul. 22, 2004

(54) Device and method for changing the function of a virtual instrument

(76) Inventors: Beat Bumann, Glis (CH); Jurjen Zoethout, Lausanne (CH); Ronald Vuillemin, Niedererlinsbach (CH)

Correspondence Address: William H Logsdon, 700 Koppers Building, 436 Seventh Avenue, Pittsburgh, PA, 15219-1818, US

(21) Appl. No.: 10/469,716

(22) PCT Filed: Mar. 1, 2002
(86) PCT No.: PCT/CH02/00126

(30) Foreign Application Priority Data
Mar. 2, 2001 (CH) 402/01

(51) Int. Cl. G09B 23/28

(52) U.S. Cl. 434/262

(57) ABSTRACT

The invention relates to a device for changing the function of a virtual instrument which is designed for use in a simulation system for surgical interventions. The inventive device is characterized in that it exchanges various virtual instruments that are associated with the same real handhold of the simulation system. A defined actuation of the handhold or an acoustic signal to be given by the user are designated to enable an input possibility in the control circuit via which one out of a plurality of virtual instruments can be chosen when the handhold is correspondingly actuated or the corresponding acoustic signal is given. After selection of the virtual instrument the display of the previous virtual instrument is replaced by the display of the selected virtual instrument. The inventive device enables the surgeon to carry out a simulated operation with various instruments without having to put down the handhold.

This invention relates to a device for changing a function of a virtual instrument which is designed for use in a simulation system for surgical interventions, whereby various virtual instruments can be selected using the same real handle of the simulation system, as well as a method for the use of said device.

The prior art describes a variety of simulation systems for surgical interventions. In these operations, the surgeon uses a handle of a virtual instrument, e.g. scissors, a clamp, a scalpel or a similar instrument, to perform the surgery being simulated by means of a virtual image of the operating area represented on a screen, e.g. an image of the abdomen or individual vessels. In reality, the surgeon must repeatedly replace the instrument being used with another instrument. During endoscopic surgeries, this change must be executed by extracting the instrument from the trocar and introducing the new instrument. During vascular surgeries, for example, the catheter is removed and replaced by another one. The prior art does not describe any devices that provide easy and realistic assistance to the surgeon performing the simulated operation.

On the basis of this prior art, the object of the invention is a method and a device that provide easy and realistic assistance to the surgeon or surgeons performing the simulated operation.

The invention teaches a device characterized by the fact that a control circuit is provided, that a defined actuation of the handle is specified, so that in the event of an actuation of the handle in the control circuit, an input option is enabled, by means of which one of a plurality of virtual instruments can be selected, and when the virtual instrument is selected, the display of the original virtual instrument can be replaced by the display of the virtual instrument that has just been selected.

The device taught by the invention has the advantage that the virtual instruments, i.e. the mechanical and electronic components that are downstream of the handle, need not be replaced, which normally can only be done by a skilled technician, and that the extraction of the instrument from the trocar or from a vessel is replaced by pulling the handle back a predefined distance, whereby after the selection of the new instrument, the display is switched to said new instrument, without requiring additional work on the part of the person performing the simulation. Thus the surgeon can perform a simulated operation with different instruments without even having to put down the handle.

The selection of the new instrument itself can be made by displaying the virtual instruments available for selection on the screen illustrating the site of the surgery, whereby the selection can be made from a contextual menu by rotating the handle around its longitudinal axis or by pulling along the longitudinal axis of the handle. Alternatively, the selection can also be made by a voice command, and can be made by programming the names of the virtual instruments and/or by an abstract selection (e.g. by numbers).

The initiation of the selection enabling process can correspond to an initialization of the virtual instrument. For that purpose, the user will pull on the handle and extract the tubular lower portion of the virtual instrument against the force of the drive that is integrated into the suspension of the simulation device, and thereby, after overcoming a force threshold to be measured by a force sensor, will set the simulation device to a predetermined position which has been calibrated on a one-time basis. The same objective can also be accomplished by rotating the handle against an increasing restoring force that is applied by the drives, whereby after a force threshold to be measured by the force sensor is exceeded, the simulation device is set to a predetermined angular position. Alternatively, it is also possible to detect the retraction and/or twisting of the tubular bottom part with markings and photoelectric barriers or other triggering measurement systems.

The method taught by the invention is described below. The screen of the simulation system shows the site of the operation, for example as the surgeon would see it through an endoscope. The surgeon thereby sees the simulated terminal section of one or more instruments, in particular the simulated terminal segment of a virtual instrument, the actual handle of which he is holding in his hand. It is thereby irrelevant whether the device does or does not detect a force feedback.

By pulling the handle back past a specified point or by squeezing the handle a pre-defined number of times or by actuating a trigger button located on the handle, a control circuit of the simulation device is switched so that in the event of such an actuation of the handle, information can be input into the control circuit. This input capability can be used to select from a plurality of virtual instruments.

In particular, a window in the sense of a contextual menu can be displayed on the screen. This menu can list the available instruments one after another, so that by rotating or pulling on the handle, a cursor can be used to select the individual instruments one after another.

The instruments available for selection can also be displayed in the form of a circle around a center point, in which case the handle can advantageously be rotated in the manner of a joystick to select the individual instruments.

After the (confirmed) selection of the virtual instrument, the display of the original virtual instrument is replaced by the display of the selected virtual instrument. The confirmation itself can be executed in a number of different ways. For example, the confirmation can take the form of another type of movement, such as a rotation of the handle for a selection that is made by pulling the handle, or by pushing or pulling the handle when the selection is made by rotating the handle. Furthermore, a single or repeated squeezing of the handle can be considered a validation, and finally, the validation can also be made by pressing the above mentioned trigger button.

In addition to the selection by moving the handle, a voice control system can also be provided, whereby simultaneously the instruments available for selection are displayed on the screen or not. The voice control system can require that the actual names of the instruments be spoken, with or without control words, or may require code words or code numbers, in which case a visual presentation on the screen is advantageous.

1. Device for changing a function of a virtual instrument which is designed for use in a simulation system for surgical interventions, whereby various virtual instruments can be selected using the same real handle on the simulation device, characterized by the fact that a control system is provided, that a defined actuation of the handle or an acoustic signal to be emitted by the user is provided, so that in the event of such an actuation of the handle, or in the event of such an acoustic signal, an input capability into the control system is enabled, by means of which one of a plurality of virtual instruments can be selected, and that when the virtual instrument is selected, the display of the original virtual instrument can be replaced by the display of the selected virtual instrument.

2. Device as claimed in claim 1, characterized by the fact that the defined actuation is the pulling of the handle back past a determined point in the direction of the longitudinal axis of the handle.

3. Device as claimed in claim 1, characterized by the fact that the defined actuation is two or more squeezes on the handle within a predetermined time interval.

4. Device as claimed in claims 1 to 3, characterized by the fact that the enabled input capability comprises a display of the virtual instruments available for selection on the screen of the simulation system that displays the site of the surgery, that the control circuit makes it possible to change the virtual instrument currently selected by rotating the handle around the longitudinal axis of the handle, and that the control circuit can be used to display on the screen the virtual instrument currently selected by rotating the handle, and that the selection of the respective currently selected virtual instrument can be validated by pushing the handle forward past the predetermined point or by an actuation of the handle.

5. Device as claimed in one of the claims 1 to 3, characterized by the fact that the enabled input capability comprises a display of the virtual instruments that are available for selection on the screen of the simulation device that displays the site of the surgery, that it is possible with the control system to change the virtual instrument currently selected by pulling the handle farther along its longitudinal axis, that the control system can be used to display the virtual instrument currently selected on the screen by pulling the handle, and that the selection of the virtual instrument currently selected can be validated by rotating the handle by a predetermined angle or by an actuation of the handle.

6. Device as claimed in one of the claims 1 to 5, characterized by the fact that the predefined position in the longitudinal direction or in the form of an angular rotation around the longitudinal axis of the handle can be defined by the passing of a predetermined threshold value of the tensile force or torque measured by a force sensor.

7. Device as claimed in one of the claims 1 to 3, characterized by the fact that the enabled input capability is an activation of a microphone, so that the desired virtual instrument can be selected by a voice command.

8. Device as claimed in claim 7, characterized by the fact that the input capability also comprises the display of the virtual instruments available for selection and/or the words to be spoken to make the selection on the screen of the simulation device that displays the site of the surgery and/or that the selection of the currently selected virtual instrument can be validated by pushing the handle past the predetermined point or rotating the handle by a predetermined angle or by actuating the handle.

9. Device as claimed in one of the claims 1 to 8, characterized by the fact that the virtual instruments comprise at least the group of the instruments clamp, scalpel, scissors, coagulation unit and laser.

10. Method to change a function of a virtual instrument which is designed for use as part of a simulation system for surgical interventions, whereby various virtual instruments have the same real handle of the simulation system, characterized by the following steps:
that an actuation of the handle or an acoustic signal emitted by the user enables an input capability in a control circuit of the simulation system,
whereby one of a plurality of virtual instruments can be selected by means of this input capability, and
that after the confirmation of the selection of the virtual instrument, the display of the original virtual instrument is replaced by the display of the selected virtual instrument.
